(19) United States
(12) Patent Application Publication
(10) Pub. No.: US 2008/0216172 A1
(43) Pub. Date: Sep. 4, 2008

(54) SYSTEMS, METHODS, AND APPARATUS FOR SECURE TRANSACTIONS IN TRUSTED SYSTEMS

(76) Inventors: Victor Forman, Pikesville, MD (US); Michael Mayberry, Phoenix, AZ (US); Karl Ginter, Beltsville, MD (US)

Correspondence Address: DAVID P. LENTINI, 53 Clark Road, North Berwick, ME, 03906-6310, US

(21) Appl. No.: 11/777,267

(22) Filed: Jul. 12, 2007

Related U.S. Application Data
(60) Provisional application No. 60/807,337, filed on Jul. 13, 2006.
(60) Provisional application No. 60/889,821, filed on Feb. 14, 2007.
(60) Provisional application No. 60/916,285, filed on May 5, 2007.

(51) Int. Cl. G06F 21/00

(52) U.S. Cl. 726/21

(57) ABSTRACT

Systems, methods, and software for protecting the identities of individuals, groups, and organizations are provided. In one embodiment, the systems, methods, and software provided by the present invention include a challenge-response architecture based upon entity-specific knowledge for verification of identity. In one aspect, a method for authenticating a first entity to at least one other entity includes creating an authenticator effective to authenticate said first entity to said at least one other entity; providing said authenticator or a substantially secure derivative thereof to an intermediary authentication service configured to interrogate said first entity; receiving a response to an identity interrogation from said first entity at said intermediary; and comparing at said intermediary the content of said response, or a derivative of said content, to said authenticator or said substantially secure derivative thereof to generate an estimation as to whether said first entity is authentic at said intermediary.

### 1 CROSSREFERENCE TO RELATED APPLICATIONS

The present U.S. patent applications claims priority under 35 U.S.C. § 119(e) from provisional U.S. patent application Ser. Nos. 60/807,337, filed 13 Jul. 2006; 60/889,821, filed 18 Oct. 2006; and 60/916,285, filed 5 May 2007. The entire disclosure of each of these provisional patent applications is incorporated herein by reference in its entireties and for all purposes.

### 2 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright 2007, DialSafe, Inc.

### 3 BACKGROUND OF THE INVENTION

3.1 Field of the Invention

The present invention provides systems, methods, and software for establishing the identities of individuals, groups, and organizations in distributed computing architectures, including, in some embodiments, a challenge-response architecture based upon certain knowledge for verification of identity. In other embodiments, the present invention provides for the automatic recovery of “locked out” accounts without third party involvement, data compartmentalization, and a mechanism for recovering from data compromise. The present invention has applications in the areas of computer science, computer security, and electronic commerce.

3.2 The Related Art

Systems that rely upon software to establish user identity, credentials, or rights to operate require specialized protection to prevent attacks that exploit their authentication and authorization components. Such attacks can be directed against elements of the underlying operating system and applications software rather than the authentication and authorization components of the systems. Collections of techniques, including software and hardware techniques have been employed to “harden” these layers and provide processing platforms that operate in a defined way and are resistant to tampering; these are called “trusted systems”.

Systems exist that provide for “challenge-response” and even “challenge-response” using personal information as aspects of the challenge and response. However, these systems must operate from a central authentication service (which may include multiple data servers and computers); and so they provide no means for distribution of authentication information between the central service and the user. (See, e.g., Published U.S. Patent Applications Nos. 2004/0123162, 2005/0039057, 2003/0126092, 2006/0036868, 2005/0216768, 2003/0033526, and 2003/0154406.) Furthermore, as illustrated in the just-cited published patent applications, many of these systems require a user connection through a web service or other online technique.

Most computing systems today have no effective way to recover from a compromise to a user's account or identity credentials, nor do they permit a comprised user account or identity credentials to be automatically recovered after a compromise. Today, these systems recover from a security breach by deleting the compromised account(s) and credential(s), and then creating a new account(s) or credential(s), or by resetting passwords and authenticators associated with the account(s) or credential(s) and communicating the reset information to the user after the identity of the user is manually verified. This is burdensome where the account or credential is used in automated systems or when the user is not known to the person resetting the account. Elaborate workarounds have been implemented to try to obviate the failings of this approach.

In other instances, the computing systems comprise a intermittently connected distributed transaction system, e.g., a central system coupled with a remote authentication device such as a card reader at a checkout stand in a grocery store or drug store. In these types of systems, there is no way for the distributed portion(s) of the transaction system to request additional information or validation from an authentication device, since that information is kept and processed at the central service. In some systems having the distributed architecture just described, there is a need for a mechanism to determine with assurance whether a user has answered correctly a series of challenge-and-response interactions where the responses are both received and checked on the distributed portion of the transaction system and where the responses are not communicated with a central service for checking. Mechanisms for this use are relevant for both unassured and assured processing platforms.

Also, trusted systems have no way of ascertaining whether a user of a system is actually authorized, and whether the user is actually who they say they are. There is a need for a system that permits a trusted system to ascertain, and then attest to its ascertainment, the degree of authenticity proven by a user.

Furthermore, there exists a need for a system that is able to compute these checks in distributed authentication devices without exposing the expected responses in the event the distributed portions of the system is compromised. Lastly, the authentication device needs to provide a robust attestation (i.e., not susceptible to spoofing) indicating the success or failure of the checks.

It is desirable that the authentication techniques are also compact, as many authentication devices have limited memory and/or processing capabilities. Secure processing environments, i.e., processing environments that are tamper resistant and are physically secured, also suffer from this limitation. Moreover, tamper resistant environments are not tamper proof; and thus cannot be relied upon for storage of keys and other cryptographic materials.

Access to a user compartment is by single authentication such as password. There is no mechanism for recovery of a compartment using alternative authentication mechanisms.

Current trusted systems have no way of ascertaining whether a user of a system is actually authorized, and whether the user is actually who they say they are. There is a need for a system that permits a trusted system to ascertain, and then attest to its ascertainment, the degree of authenticity proven by a user. There also is a need for a system that can generate authenticators using an automated process, so that these authenticators may then be used for authentication. Finally, a need exists for challenge-response systems that can be distributed, and that can operate in an offline or semi-connected mode. The present invention meets these and other needs.

### 4 SUMMARY OF THE INVENTION

The present invention provides systems, methods, and software for protecting the identities of individuals, groups, and organizations (hereinafter called “entities”). In one embodiment, the systems, methods, and software for protecting the identities of entities provided by the present invention include a challenge-response architecture based upon entity-specific knowledge for verification of identity. In other embodiments, the present invention provides for the automatic recovery of “locked out” accounts without third party involvement, data compartmentalization, and a software redundant mechanism to “go to” and make the primary in event of a data compromise.

In a first aspect, the software, systems, apparatus, and methods of the present invention provide secure, distributed computer systems having an ability to make assertions as to the identity of a user without regard to its membership in a federated identity management scheme. Each system may make independent determinations as to whether a user requesting access to any particular system can respond to the challenges identified by one or more authenticators. Furthermore, the distributed system may provide pre-calculated credentials (e.g., equivalent to cached credentials on a laptop) along with the distributed system's assertion that it has performed the validation of the user's identity in accordance with the requirements of the authenticators. The credentials, along with the attestation of identity, may be relied on by any system that trusts the ability of the distributed system to process the identity check with integrity.

In another aspect, the software, systems, apparatus, and methods of the present invention provide mechanisms to establish a recoverable identity. Such mechanisms can include authenticators that include a list of standard questions, a plurality of secured authenticators, and mechanisms for failing-over from a first set to a subsequent set of authenticators in the event of a compromise of the first authenticators. In one embodiment, the secured authenticators include an optional set of questions, a signed list of answer hashes, in which each answer hash corresponds to one of the questions, an associated set of user credentials, and a digital signature of a trusted party over the set of hashes and credentials.

In one embodiment, the present invention provides collections of challenge-response question-answer pairs, which extends to operating within hardware devices, network appliances, and specifically within the auspices of a trusted processing environment, such as those described by TPC's trusted processing module (“TPM”). A system using secure processing techniques, a TPM, or a trusted crypto-processor (collectively, a secure processing method) may validate a set of plain-text responses provided by a user against a set of secured responses within the secure environment and provide a cryptographically robust credential indicating the success or failure of the checks. Furthermore, a secure processing method may provide attestation that a previously provided digital credential (or set of credentials) was actually properly authenticated in accordance with the algorithms herein.

The present invention thus provides a secure processing environment that can recover from compartment failures by associating a plurality of authentication sets with a compartment. Still other advantages and benefits of the present invention will be apparent when the following disclosure is read in conjunction with the accompanying drawings.

### 5 BRIEF DESCRIPTION OF THE DRAWINGS

FIG. 1 illustrates a system in accordance with one embodiment of the invention.

FIG. 2 is a flowchart illustrating the prior art process of authenticating a user.

FIG. 3 is a flowchart illustrating one embodiment of a process of authenticating a user using the present invention.

FIG. 4 illustrates an authentication server and its components in accordance with one embodiment of the invention.

FIG. 5 illustrates the operation of an authentication server in accordance with one embodiment of the invention.

FIG. 6 illustrates one embodiment of the components in a system for the automated generation of authenticators used by the various embodiments of the current invention.

FIG. 7 illustrates one embodiment of a method for the automated generation of authenticators used by the various embodiments of the current invention.

FIG. 8 illustrates the use of a secure processing environment to generate authenticators in accordance with one embodiment of the invention.

FIG. 9 illustrates authenticators in accordance with one embodiment of the invention.

FIG. 10 illustrates a method for processing authenticators by a secure processing environment in accordance with one embodiment of the invention.

FIG. 11 illustrates a method for processing authenticators where all the responses have not been provided beforehand in accordance with one embodiment of the invention.

FIG. 12 illustrates an authentication device and its components in accordance with one embodiment of the invention.

FIG. 13 illustrates the operation of an authentication device on a communications device in accordance with one embodiment of the invention.

FIG. 14 illustrates schematically one example of a typical computer apparatus suitable for use with the present invention.

### 6 DETAILED DESCRIPTION OF SOME EMBODIMENTS OF THE INVENTION

### 6.1 Definitions

Unless otherwise noted, the following terms are defined as shown:
Term Definition
Account Issuer The issuer of any account that may be used in connection with the responses supplied by a holder of the account(s).
Authentication device A data entry device that displays questions and prompts the user for answers. May be a data entry terminal, a cellular telephone, a POS keypad, or any other device capable of accepting input data.
Challenge-response set A set of questions (or references to questions) and expected results (possibly encoded).
Device issuer The issuer or service providing for a specific authentication device (or device that embeds authentication device technology).
Expected Response The response expected from the user. A response can be encoded using encryption or hashing producing).
User, Holder, Account Holder, Cardholder Classes of users that interact with the system using an authentication device.
   Generally, the person or entity from which queries are generated and through which responses are input and authorized, or rejected (if the supplied responses do not match satisfactorily the responses previously prepared or input) by the person attempting to obtain authorization for the account, but not in possession of the responses previously supplied to by the holder and, about which, no one other than the actual, and/or authorized person(s) or device would have any
Crypto-Processors Dedicated processing units or special purpose hardware systems, with isolated storage and tamper-resistance built in. Provides protected storage of cryptographic materials along with cryptographically
Secured Environment A processing environment that is tamper resistant and is physically secured. Tamper resistant environments are not tamper proof, and thus cannot be relied upon for storage of keys and other cryptographic materials. They may be relied upon to operate with reasonable application integrity. (Microsoft XBOX, Phoenix 5 BIOS, other embedded devices).
Secure Processing Techniques Processing techniques, such as process state and curtained memory that are used to segregate secure processes from insecure processes. Secure processing techniques may use embedded cryptographic techniques to govern the applications that may be designated as “secure”. Cryptographic materials storage may be managed using secure processes (e.g.,
Trusted Processing Modules (TPM) Chip-based cryptographic modules constructed in accordance with the Trusted Computing Consortium. TPM chips provide crypto-services.

### 6.2 Authentication System

In one aspect, the present invention provides an entity authentication system. In one embodiment, the authentication system provided by the invention solicits responses to a system-selected set of questions from an entity registered with the system (a “holder”) and provides authentication decision results based upon the holder's responses. Unlike similar systems, the present invention provides for the distributed processing of entity authentication using comprising one or more sets of portable secured challenge-response materials. A set of portable secured challenge-response materials is called an Authenticator. This processing of authenticators may be performed in an online mode, or, with suitable caching, in a semi-online or offline mode. Furthermore, the system of the present invention operates within trusted and embedded environments, including small footprint devices such as a card-swipe reader commonly found at retail establishments.

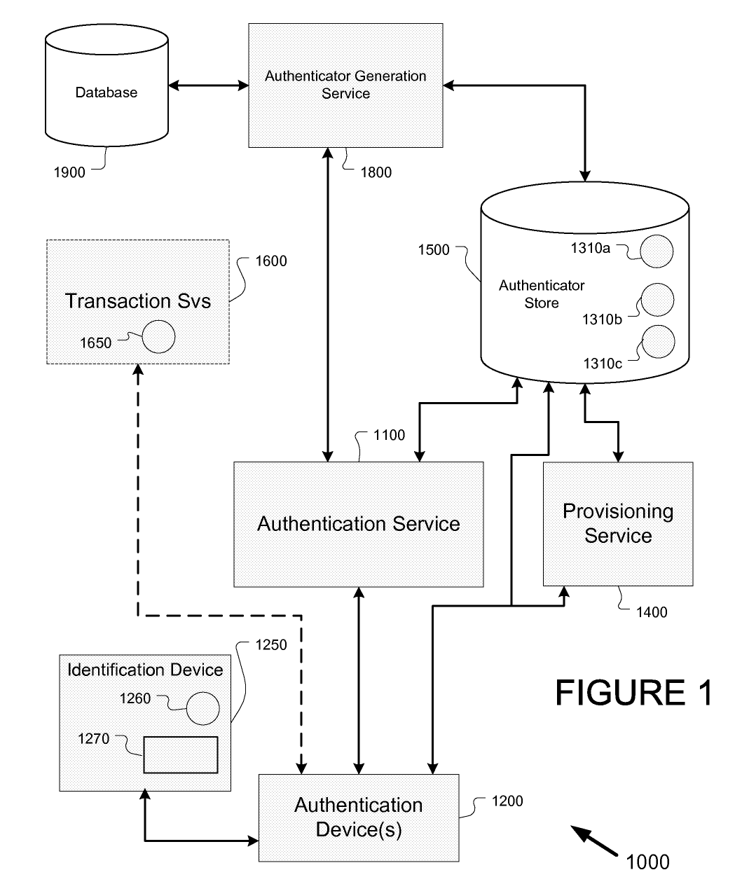

FIG. 1 illustrates one exemplary embodiment of an authentication system in accordance with the present invention (1000), comprising at least one authentication service (1100) and one or more authentication device(s) (1200), which provide an interface between a user device providing authentication information about a user as described hereinbelow (and, further, are configured to determine a user's authenticity as described herein. Examples of authentication devices include without limitation: card-swipe machines, radio-frequency ID (RFID) readers, magnetic card sensors, signal receivers, mobile computers, PDAs, cellular telephones, and other devices effective to receive and process authenticators used to identify a user as described hereinbelow. Still other suitable authentication devices will be apparent to those having ordinary skill in the art. In some particular embodiments, an entity provides the authentication device with its identity information, such as a credit card number, account number, or other machine usable identifier. Alternatively, authentication device 1200 may communicate with one or more identification devices (1250) to obtain a entities identity information as indicated by identifier 1270. Identification devices may also include one or more authenticators (1260) that are configured to be received and processed by the authentication device as described herein. In some particular embodiments, an identification device and an authentication device may be combined. Such embodiments may include so-called “smart cards”, cellular telephones, and similar devices. In addition, authenticators (1310a-1310c), also described below (Section 6.8), are transmitted between various components of the authentication system (as described below) and at least one authentication device. The Figure also illustrates a provisioning service (1400) associated with a authenticator store (1500) that stores the authenticators. The authenticator store also interoperates with one or more authentication server(s) to exchange the authenticators. The authenticator store further receives additional authenticators from an Authenticator Generation Service (1800). The Authenticator Generation Service interoperates with one or more information databases (1900) or other sources of input to produce new or replacement authenticators. One example of methods and systems for using materials in databases to generate authenticators is the automated generation of questions and answers use to construct challenge-response sets as found in Published U.S. Patent Application No. 2004/0189441. Upon receiving a generation request from the authentication service, the Authenticator Generation Service (1800) creates one or more authenticators and provides these authenticators to the Authentication Service (1100). An interface to an optional transaction service (1600) including authenticators (1650) is also shown.

Each service of the present invention may be configured to operate on a single computer or server of conventional or specialty design, or configured to operate on two or more different computer or servers that are optionally at the same or different physical locations. The precise mechanism for allocating specific processes and services to one or more computers is well understood by those skilled in the art. If a plurality of computers are used to host one or more services, each computer is operably linked with the other computers using one or more communications means, such as telephony, TCP/IP-based or wireless networking. The method selected of operably linking the various components is implementation dependant and is well understood by those skilled in the art.

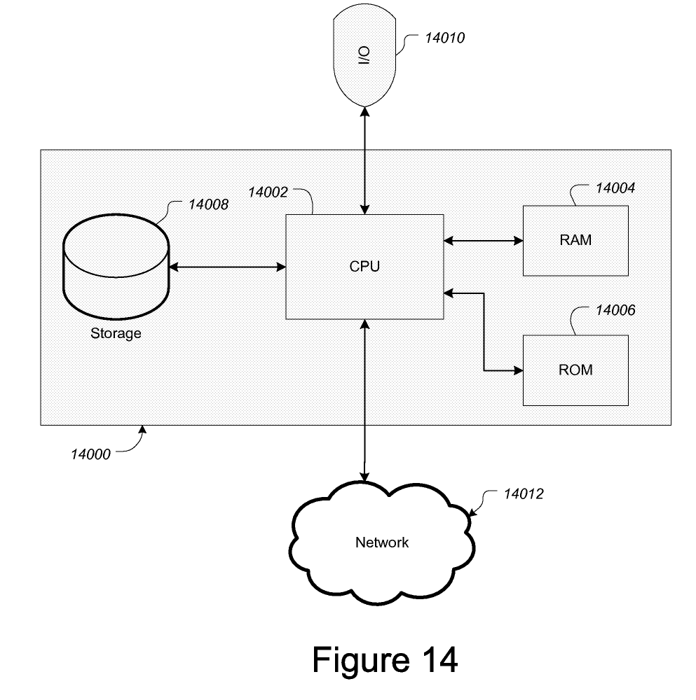

In one embodiment, each service is hosted on a computer system comprising computer hardware and software, the hardware typically comprising processor, memories, and disk storage space, and constructed using means well understood in the art (see FIG. 14). Other equivalent configurations to provide the functions of the authentication service will be familiar to those having ordinary skill in the art. Additionally, one or more means of communication are provided to the service, preferably network connections, such as those provided for Ethernet or wireless Ethernet service. Alternatively, the communications means may be provided using serial or other adapters such as USB and Firewire. The service's hardware components can be of commercial construction, such as those provided by Dell Computers, Austin Tex. A plurality of authentication servers may be provided when deployed in a redundant or fault-tolerant environment, the configuration of which is understood by those having ordinary skill in the art.

Returning again to FIG. 1, in one embodiment of the invention each instance of a communications link illustrated comprises a communications protocol that is configured to enable communication among two or more services and provide a means for communicating authenticators and/or specific protocols related to the authentication service. For example, an instance of the communications protocol can be a means for receiving requests from a holder of an authentication device, and then providing a response to the authentication device based upon processing within the authentication service. The communications protocol may be implementation-specific and take advantage of features of various protocols and technologies already well understood by those skilled in art. In a more specific embodiment, two such features are the protection of contents for (1) integrity and (2) privacy. Protection for integrity involves, in some exemplary embodiments, hashing, checksums, or other means well understood in the art. (See, e.g., Published U.S. Patent Application No. 2006/0036857.) Protection for privacy generally means encryption or ciphering of the contents being transmitted. Various levels of protection are afforded by differing technologies, as will be understood by those having ordinary skill in the art. The authentication protocol makes use of implementation appropriate technologies as desired by the implementer. The communication service and the communication protection features it implements may be partially controlled by the account information associated with an account issuer. Implementation of these details will be familiar to those having ordinary skill in the art.

### 6.3 Transaction Service and Transaction Review

In one embodiment, an authentication system (1000) of the present invention is configured to operate with transaction services (1600) including those provided by open-loop transaction providers, including credit- and debit card providers such as Visa and MasterCard, and those provided by closed-loop transaction providers, such as gift card and merchant account card systems. Such transaction systems are well understood to those skilled in the art. A transaction system may be implemented as a server, set of servers, services, or other means known to those skilled in the art, although such details are outside the scope of the present invention.

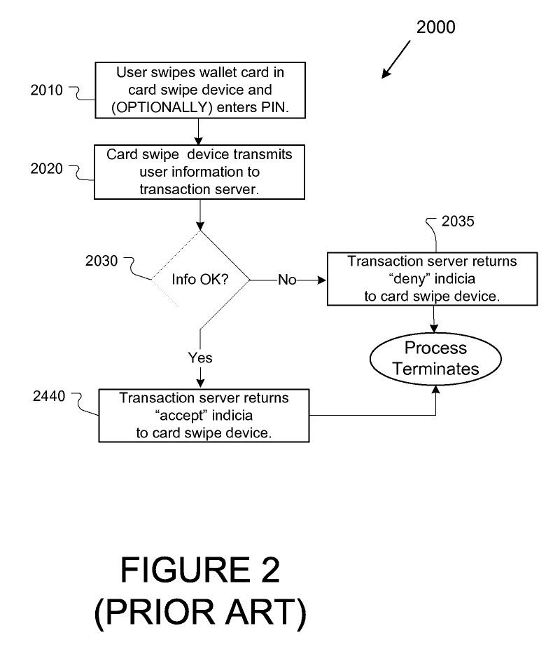

Before illustrating embodiments of methods provided by the invention for authentication and transaction approval, and way of comparison, an example of a prior art transaction approval process (2000) is shown in FIG. 2. There, a user interacts with a card swipe device (2010), e.g., a point of sale or PIN terminal such as those found at most retail establishments. (However, the example illustrated in the Figure is not limited to card swipe devices, as will be understood by those having ordinary skill in the art.) The user may enter a PIN or other password during the interaction. The card information (e.g. identity information) and any entered PIN or password are transmitted to a transaction service (2020). The card information and other information are checked by the transaction service, using various computers and servers located therein, and the transaction is approved or denied by the transaction service. The system then responds with an approval or denial (2030), for example by providing denial (2035) or approval (2035) indicia before terminating.

The present invention improves upon this simplistic protocol by allowing the transaction system to request additional identification details of the user at the time of transaction using an automated process. The automated process provided by the invention permits the transaction system to determine the identity of the user with a higher degree of certainty and allows the user to recover secure access to their information more quickly following the loss or compromise of the user's identity. Such features are advantageous when the card is suspected of being used fraudulently, or when there has been a suspected breach of data security at a card processor, or other entity that holds card information.

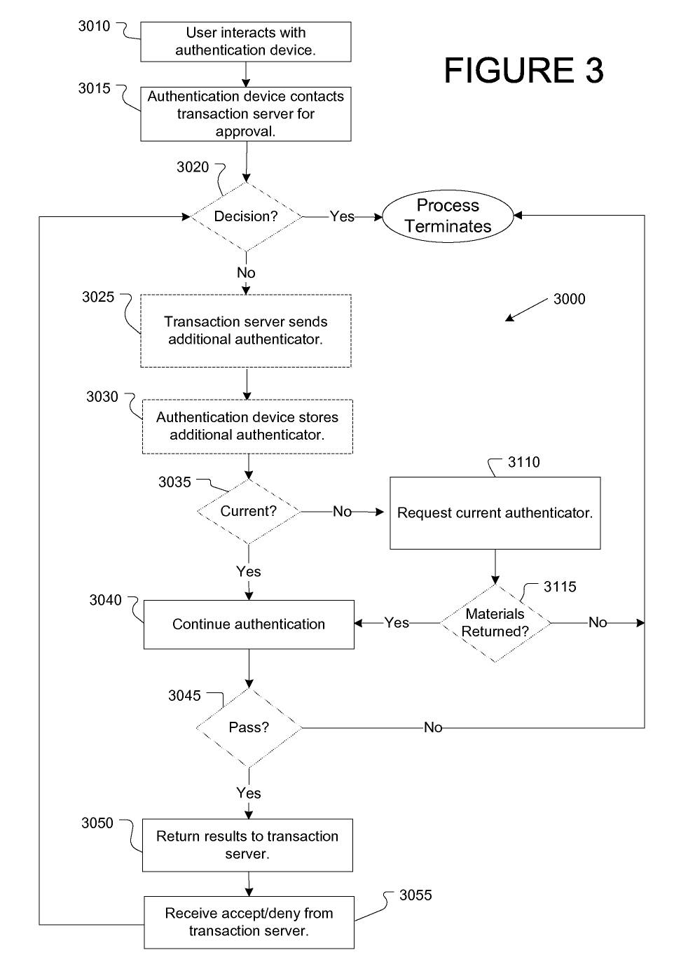

An exemplary embodiment of a transaction approval process provided by the present invention (3000) is shown in FIG. 3. A user interacts with an authentication device (3010) (e.g., the authentication device (1200) of FIG. 1), such as a point-of-sale or PIN terminal, card reader, or scanner of the type found at most retail establishments to provide identity and/or account information. In some embodiments, the user manually enters identity information such as an account code or other string for identifying a user to the system. In other embodiments, the user's interaction providing identity information is partially or completely automated using an identification device (e.g., identification device (1250) of FIG. 1), e.g., a wallet card as described in the example of the prior art just provided. The user also may enter a PIN or other password although, depending upon features of the system, the identifier may be read by a drive, scanned by an RFID reader, or other technology as will be familiar to those having ordinary skill in the art. In one embodiment, the identification device is a wallet card formatted in accordance with the ID-1 format card as defined by ISO standards, such as a credit or debit card, which additionally may include a magnetic stripe, smart card semiconductor device, RFID tag, or other machine-readable attribute that can carry identification information (e.g. identifier 1270 in FIG. 1) an authenticator (e.g., the authenticator (1260) in FIG. 1). Other card formats may be used without deviating from the spirit of the invention, and can be implemented using the information provided herein by those having ordinary skill in the art.

Using information from the identification device as described below, in one embodiment the authentication device follows a modified transaction approval process to determine if the transaction is acceptable using the following exemplary operations with reference to the exemplary elements described with respect to the system illustrated in FIG. 1 and the method illustrated in FIG. 3. The authentication device (1200) contacts a transaction service (1600) and forwards identification information (obtained from the identification device or from the user) to the transaction service (3015). In some embodiments, the authentication device (1200) may also perform the holder verification steps of the process prior to contacting a transaction service. In one embodiment, these steps are performed sequentially first, and then the authentication device forwards the verification results and, optionally, at least one indicia of the authenticator used to verify the identity of the holder to the transaction service (1600) for processing. Additional materials may be forwarded to the transaction service by the authentication device in accordance with specific embodiments of the invention, including, but not limited to, transaction details and purchase details.

The transaction service returns a decision on the transaction (3020) and communicates these results back to the authentication device. If the transaction service makes a decision, i.e., the transaction is approved or denied, then the transaction process ends. Alternatively, the transaction service optionally requests additional information to authenticate the user using a “further authentication required” response (3025); this response is also referred to herein as a “conditional approval”. In some embodiments, the “further authentication required” response further includes additional authenticators (1650) to be used by the authentication device to authenticate the user. Optionally, the response may include additional parameters or instructions (or both) for the authentication device, such as specific indicia of challenges and authenticators to use, or may provide further constraints on the materials, such as their maximum age, version number, or number of questions to be asked. These authenticators may be stored in an identity device, stored in the authentication device, transmitted to the authentication device as part of the “further authentication required” response as described above, or may be obtained by the authentication device from an external service as described below. In some embodiments, the authentication device uses additional authenticators (1310a-1310c) such as those that are provided by the authenticator store (1500) to complete the authentication process.

In those embodiments in which the authentication device receives authenticators as just described, then the authenticators are stored within the authentication device (3030), e.g., within a memory such as a cache. The authenticators may also be stored within an identification device. The authentication device then determines if it has a current copy of required authenticators (3035). If the authenticators are not current, then the authentication device requests current authenticators from the authentication server or authenticator store (3110). The request may be made using the same communication method as used to communicate with the transaction service, or it may use a different one. In more specific embodiments, the request includes one or more of the following items: information read from the identification device, information provided by the transaction service, information from a previously stored set of authenticators, or some combination of these items. These items are used by the authentication service (or authenticator store) to provide the appropriate authenticators (1310a-1310c) to the authentication device. In one particular embodiment, an authenticator request is fashioned as a URI. In an alternative embodiment, the request is a database or directory service query. In yet other embodiments, the request is a service request encoded using SOAP. In some embodiments, common Internet-based protocols such as HTTP, FTP, TFTP, STMP, or SMS may be used to request and obtain authenticators. The use of other additional protocols to request and obtain authenticators are understood by those skilled in the art.

The authentication device then receives a response from the authentication service or authenticator store. If the response comprises the requested (or updated copies of) authenticators (3115), then the authentication device stores these authenticators within the authentication device, e.g., within a memory such as a cache, and continues with the authentication process (3040). If the response does not contain the required authenticators, the authentication returns an error and the process terminates.

In some embodiments, if the authenticators are provided, either from the communication with the transaction service, or a communication with an authentication service or authenticator store, or some combination of communications with one or more services, then the authentication device uses the authenticators as described herein provide a challenge-response test to the user, which may include one or more challenges, and determines if the user passed the challenge-response tests (3045). This test may occur locally within the authentication device, or at the authentication service, at the transaction service, or at some combination of these services as described herein. If the user passed the test(s), then the authentication device returns the results of the authentication process to the transaction service (3050) and receives the decision from the transaction server (3055). In some embodiments, the authentication device is required to repeat the transaction communication (3015) in order to get an approval.

The foregoing processes and devices can be configured and implemented using methods and equipment known to persons having ordinary skill in the art. In addition, variations of these processes can be developed without deviating from the scope or spirit of the invention. One such variation is that the authentication device pre-authenticates a user based upon the materials obtained from an authorization materials generation service or authorization materials store, and then contacts the transaction service after authentication occurs. This simplifies the transaction protocol at the cost of requiring all users to undergo additional authentication. Still other variations will be apparent to persons having ordinary skill in the art.

### 6.4 Authentication Service and Server

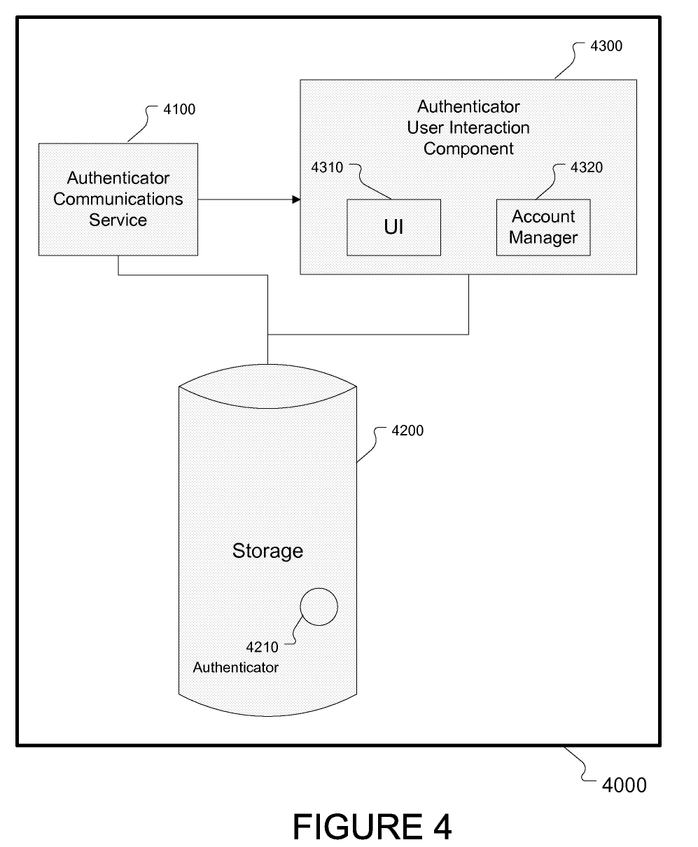

FIG. 4 illustrates the software components of an exemplary authentication service (4000) of the present invention, such as shown at 1100 in FIG. 1. In one exemplary embodiment, the software components comprise an authenticator communications service (4100), which operably communicates one or more authenticators between components of the authentication services, e.g. a storage means and one or more authentication device(s) using one or more authentication protocols. The software components further comprise an optional storage means (4200) for storing the authenticators (4210), and an authenticator user interaction component (4300) for soliciting holder input during an authenticator creation and management process.

In some embodiments, the optional storage means (4200) comprises a database, file system, directory, cache, or other mechanism for storing authenticators. Depending upon the protection requirements of the authenticators, the storage means itself may be encrypted (e.g., an encrypted database or encrypted file system) in addition to the protections described below for authenticators. In some embodiments, the storage means also stores and manages associations between authenticators and external identity information, such that authenticators may be associated with external indicia of identity, such as account numbers and user IDs. The storage means can use any hardware and software capable of storing and retrieving data, and, more particularly, large amounts of data. In some embodiments, the storage means may be a separate authenticator store as shown in FIG. 1. Suitable systems for acting as the storage means, and their implementation, are known to those having ordinary skill in the art, and some embodiments are described below.

Communication with the optional storage means may be performed using any standard network protocol or service interface desired. In some embodiments, the optional storage means uses a directory or database interface. In yet additional embodiments, the optional storage means component is a service interface defined using a mechanism such as SOAP.

The authenticator user interaction component (4300) further comprises, in some embodiments, a user interface (4310), and an account manager (4320). In more specific embodiments, the user interface component is configured to enable a holder to register with the systems, initialize the authenticators by defining answers to one or more questions, and then maintain these materials on a substantially real-time or as-needed basis. In other embodiments, the user interface component uses web-based technologies to provide the user interface. In still other embodiments, a dedicated application interface is used. In yet additional embodiments, the user interface component is a service interface defined using a mechanism such as SOAP.

In some embodiments, the user interface is configured to communicate with the above-described authenticator communication service, authenticator generator, storage means, and account manager to apply a desired transform to the entered results as part of the creation and storage of authenticators; and to store the resulting authenticator(s) within a storage means.

In other embodiments, the account manager (4320) manages the associations between authorized devices, users, and an account issuer. In more specific embodiments, the account manager includes software that is configured to permit the selection of account issuer options, such as the number of questions to be used, the failover/recovery policy to use, etc. For example, the account manager permits an account issuer to require that a minimum of two questions have an expected response provided by the user in order to validate the user.

Implementation of the foregoing can be achieved by persons having ordinary skill in the art.

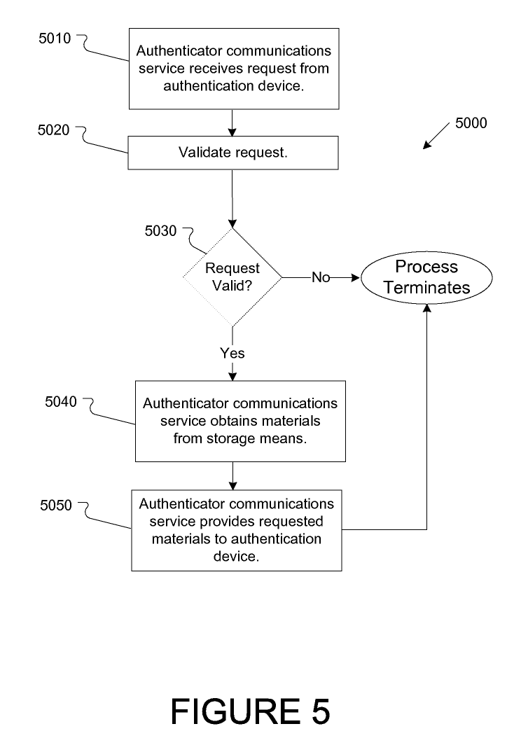

FIG. 5 is a flowchart that illustrates an exemplary embodiment of an authenticator communications service in accordance with the present invention (5000). The authenticator communications service receives a request for authenticators from an authentication device (5010), validates the request as coming from a valid device (5020) and rejects the request if the device is not valid or authorized to make the request (5030). The authenticator communication service then obtains the requested authenticators from the storage means (5040), or other storage location such as an authenticator store. The authenticator communications service then provides the requested authenticators to the requesting authentication device (5050). The authenticator communication service may provide aspects of protection for integrity or protection for confidentiality to materials sent using the authentication protocol. Implementation of such operations will be familiar to those having ordinary skill in the art.

Such processes can be implemented by persons having ordinary skill in the art. In some embodiments, the authenticator communications service may look in a plurality of storage locations for specified authenticators, such as first looking in a local cache, then looking in an authenticator store. Any number of storage locations may be searched for authenticators in accordance with an aspect of the configuration of the authentication service.

### 6.5 Authenticator Store

The authenticator store (1500 of FIG. 1) provides enterprise and large-scale storage of authenticators to the authentication system. In some embodiments, the authenticator store is a database, file system, directory, cache, or other mechanism suitable for storing authenticators. Depending upon the protection requirements of the authenticators, the storage means may be encrypted (e.g., an encrypted database or encrypted file system) in addition to the protection described below for authenticators. In some embodiments, the storage means also stores and manages associations between authenticators and external ID information, such that authenticators may be associated with external indicia of identification, such as account numbers, user identifiers, and the like. The authenticator store can use any hardware and software capable of storing and retrieving data, and, more particularly, large amounts of data. Suitable systems for acting as an authenticator store, and their implementation, are known to those having ordinary skill in the art. In some embodiments, an authenticator store may be operably connected to one or more a provisioning services, one or more authentication devices, one or more authentication services, and one or more authenticator generation services.

The authenticator store may communicate with other servers or services with using any standard network protocol or service interface desired. In some embodiments, the authenticator store uses a directory or database interface. In yet additional embodiments, the authenticator store component is a service interface defined using a mechanism such as SOAP. The store can be implemented by persons having ordinary skill in the art

### 6.6 Provisioning Service and Server

A provisioning service (1400 of FIG. 1) provides authenticator pre-deployment services to the authentication system. The provisioning service is used to preload authentication devices and identification devices with current versions of authenticators. Preloading authenticators into identification devices and authentication device with authenticators enables distributed authentication by authentication devices without online communication with an authentication service. The configuration and operation of the provisioning service will be understood by persons having ordinary skill in the art.

### 6.7 Authenticator Generation Service and Server

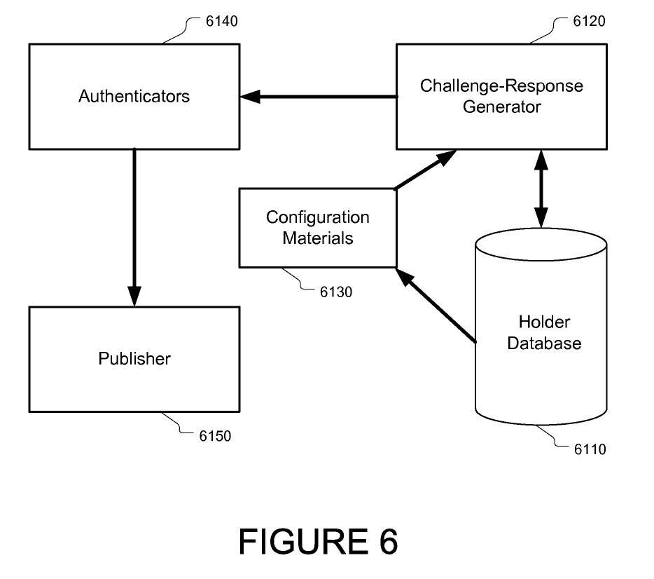

In yet other exemplary implementations, the authenticators may be generated using an automated (or quasi-automated) process provided at least in part by an authenticator generation service (e.g., such as the authenticator generation service (1800) shown in FIG. 1). As depicted in FIG. 6, such a system comprises in some embodiments a user or cardholder database further comprising user or cardholder information (6110), an Authenticator Generator process (6120), configuration materials (6130), authenticators (6140), and a Publisher (6150). In one embodiment, the Authenticator Generator (6120) uses the configuration materials (6130) to map between generic questions and answers stored as columns in a database of user or cardholder information (6110). The database (6110) may be any commercially available database, such as Oracle, MySQL, Informix, DB2, or other commercial database product. Examples of such a database is credit card issuers' records or a commercial credit bureau's database. The interface between the Authenticator Generator process and the database is implementation dependant. Common implementations include database specific interface libraries, a service interface such as defined using SOAP, ODBC, JDBC, or other interface technology. In an alternate embodiment, the Authenticator Generator uses information provided by the user interface and the account manager (not shown) in lieu of the configuration materials and database entries as input for creating authenticators.

The authenticator generation service may be run on an automated or scheduled basis, on demand in response to an operator request, or upon request of another service in the authorization system. For example, the authentication service may request the authenticator generation service creates authenticators for one or more a specific users or cardholders based upon an authentication request from an authentication device, upon request from a provisioning service, or upon request from a user using the user interface. Alternatively, the authenticator generation service can operate on a periodic or scheduled basis and produce authenticators for some or all of the entries in the database.

The Configuration Materials (6130) reference columns of the database (6110) that represent answers to a specific question. Using the database and the configuration materials, the Authenticator Generator produces authenticators (6140) that are published by the Publisher (6150) for use in the authentication processes described elsewhere in this document. In some embodiments, the publisher is responsible for sending the authenticators to an authenticator store, authentication service, or other process requiring the authenticators.

The foregoing structures and operations can be implemented by persons having ordinary skill in the art.

### 6.7.1 Table of Associations

In some embodiments, the configuration materials (6130) comprise one or more configuration items that form associations between questions and columns of a database (6110). These configuration items are called a map. For example, if the question is “what is your telephone number?” the configuration materials would provide an association between the question and the database table and column that contains each person's telephone number. The maps may be simple (e.g., a table+column reference), or may be more complex (e.g., a table+column reference+a transform that converts the data in the table+column to the expected result). An example simple map may take the form of a table and column specification “Customertable.columnid,” where customertable is the name of the database table, and the column ID is name of the column from which information is taken. Other variants, such as using fully qualified database names, host names, and other additional, more specific column specifications, may also be used. For example, a URI may be specified that includes the configuration materials. One example of such a URI is:
http://myserver?column=customertable.columnid.

An exemplary complex map may take the form of a simple map, as described above, plus the specification of an application or transform to be applied to the data taken from the column. Again, this may take several forms. One exemplary form is the specification of the column identification and a database stored procedure to convert a format of the information retrieved from the column. Alternatively, other variants, such as using fully qualified database names, host names, and other additional, more specific column specifications, may also be used. For example, a URI may be specified that includes the configuration materials. One example of such a URI is:
http://myserver/conversionprogram.php?column=customertable.columnid.

In this example, the conversion program is specified as a PHP program named “conversionprogram.php” in a form well understood in the art.

For example, each row in the table contains information about a customer. For example, their name, address, telephone number, social security number, etc. Each row in the table contains information about the customer, and the configuration information provides a map to the telephone number as a simple association, for example, a reference to customer_table.telephone_number. The configuration information also provides a complex map to the social security number, along with a function that extracts the last four digits. The authenticator generator interprets the configuration information, and causes the function to be performed on the information taken from the table prior to use in constructing authenticators.

### 6.7.2 Automated Question-Answer Generation

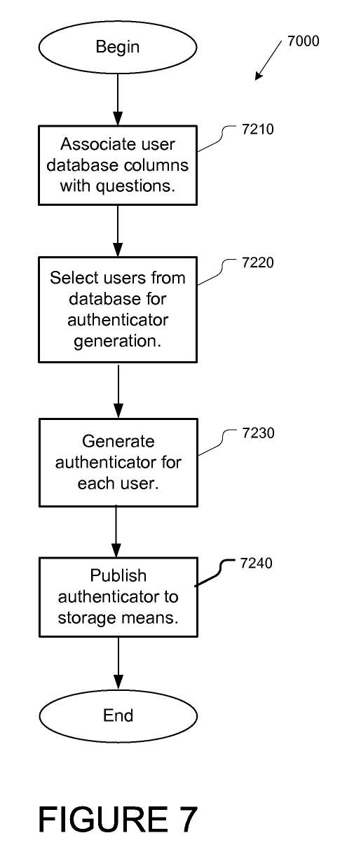

In some embodiments, the authenticators are generated using an automated process, one embodiment of which is depicted (7000) in FIG. 7. Using information found in the configuration materials, the Question and Answer Generator associates columns of acceptable responses in the database with pre-defined questions (7210). Next, a set of user or cardholders is selected from the database for the generation of authenticators (7220). Then, the Authenticator Generation process then generates authenticators (7230) for each selected user or cardholder. Finally, the Publisher publishes the newly generated authenticators (7240) to at least one storage means for use as authenticators by the authentication service. Provision of such services can be done using methods well known to persons having ordinary skill in the art.

### 6.8 Authenticators

According to some embodiments of the invention, the authenticators (e.g. 1310a-1310c, 1260, 1650, of FIGS. 1 and 4210 of FIG. 4) include questions and expected results sets. In more specific embodiments, a plurality of expected results sets is included in an authenticator. Authenticators are defined generally as electronically encoded data that has been derived form information about a user's identity and which is sufficient to provide a reasonable probability of identifying a user accurately and reliably. Examples of such data include: a optional list of standard interrogatory questions, one or more encoded challenge-response sets, credentials, and account, user id, or other identity association materials.

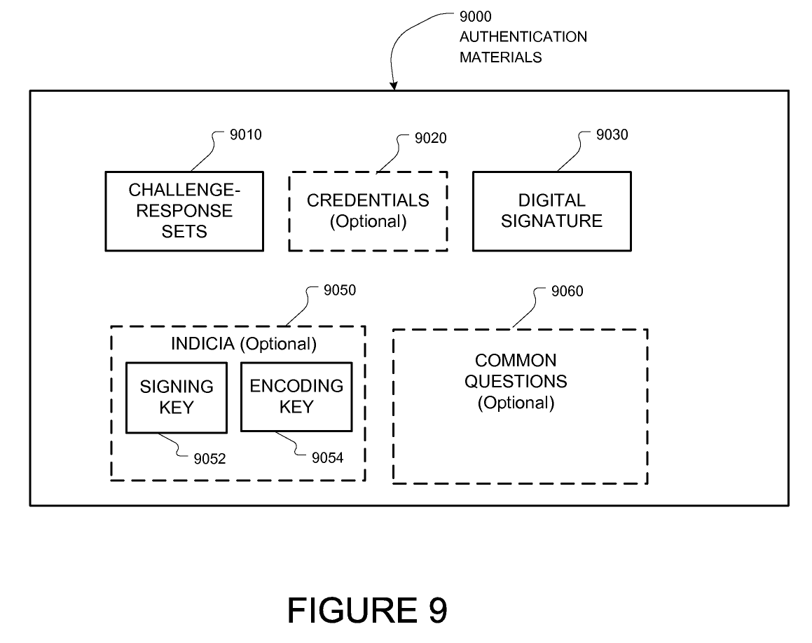

FIG. 9 illustrates an exemplary embodiment of authenticators. Authenticators (9000) comprise or more challenge-response sets (9010), the optional credentials to be used if the user is authenticated (9020), and the digital signature (9030) for ensuring integrity of the authenticator. Optional elements include indicia (9050) identifying the signing (9052) and hashing (9054) keys, and list of, or indicia of “standard questions” (9060) may be included in the authenticators if desired.

In other embodiment, the authenticators also support a mechanism for specifying the authenticator(s) and/or challenge/response sets to use failing-over from a first to a subsequent set of challenge-response sets in the event of a compromise of the first challenge-response set. In one embodiment, each authenticator includes an optional set of questions, a list of challenge response sets, further comprising at least some encoded responses, where each encoded response corresponds to one of the questions (either the common questions, or specific questions in a challenge response set), an associated set of user credentials or account information, and a digital signature of a trusted party over the set of encoding, hashes, and credentials. In an alternate embodiment, an authenticator or challenge response set may reference a standard list of questions instead of providing the question text itself. In yet another embodiment, an authenticator or challenge response set may omit the questions all together and require the authentication system to rely on one or more externally provided questions. Implementation of these details will be familiar to those having ordinary skill in the art.

In more specific embodiments, the authenticators are calculated by asking the user during creation between about ten and about fifteen questions suitable to enable determination of the user's identity, although more or fewer questions may be used to solicit responses from each user. In other embodiments, the authentication systems' set of initial questions is greater than ten, so that each user may be asked to answer some or all of the possible questions. In still other embodiments, a user's answers to the initial questions are stored as expected responses. Implementation of these details will be familiar to those having ordinary skill in the art.

In other embodiments, the initial questions are chosen so that the responses to the questions are limited in the range of desired characters, e.g., numeric only, for house address, zip code, year of birth, etc. This may be performed using transforms, edit masks, or other techniques well understood by those skilled in the art. For example, numeric-only responses are appropriate for some applications where a numeric keypad is available in the authentication device. The account issuer may optionally select the acceptable character range applicable for responses. Furthermore, the length of the recorded response may be adjusted prior to storage. For example, any answer that is shorter than four digits in length is zero-filled at the front end. Numbers that are longer than four digits may be truncated to the last four digits. Similarly, the response may be adjusted in other ways, such as conversion of case (e.g., shifting all characters to upper case). Implementation of these details will be familiar to those having ordinary skill in the art. In another embodiment, any necessary transforms and conversions of the response are associated with each question. Implementation of these details will be familiar to those having ordinary skill in the art.

In still another embodiment, the user or cardholder is permitted, and, in some embodiments even encouraged, to provide incorrect responses to the questions during the creation process. In other words, in such embodiments the user or cardholder, when providing responses to be stored within authenticators of the authentication system, provides a consistent modification factor to the correct answer, e.g., “birthdate+7 years” or “zip code 5”, etc. In more specific embodiments, the system does not validate the information provided by a user or cardholder, so the user or cardholder can provide any response he or she chooses. In still more specific embodiments, the consistent modification factor is chosen for ease of the user or cardholder's memory while complicating any attempts by a hacker to guess the response using readily available information (such as a birthdate). In still other embodiments, one or more “back-up” set of expected responses (to be explained below) is required by the authentication system and supplied by the user or cardholder. Implementation of these details will be familiar to those having ordinary skill in the art.

In some embodiments, the user or cardholder is requested to provide one or more alternate or back-up set of valid responses to each of the questions while entering their initial responses when setting up each individual user or cardholder's primary queries and expected responses. Each alternate set of responses may be manually entered or calculated. For example, if the primary set of expected responses is composed of all numeric elements, then the holder may choose the set of alternative responses to be the primary expected responses and a predefined, arbitrary number to be added or subtracted from them. The account holder, user, or cardholder may select to use a plurality of alternate expected responses, although the system functions equally well with just a primary and alternate set of expected responses. More automated authenticator generation techniques can define the predefined number to be added or substracted from the responses, either as hard-coded values within the processing algorithms or as configuration parameters to the processing steps. Implementation of these details and still other alternative embodiments will be familiar to those having ordinary skill in the art.

In one embodiment, each set of authenticators s stored using a storage means, such as a database as described above or an authenticator store. In a more specific embodiment, the authenticators are associated with a user or cardholder and are also associated with the questions selected for the user or cardholder. In a still more specific embodiment each user or cardholder is identified or associated with one or more accounts, such as credit card or cellular telephone accounts. Alternatively, a different set of authenticators may be identified by or associated with each account.

In one embodiment, each set of expected responses is encoded using hashing or cryptography using differing cryptographic keys, and the encoded expected responses are associated with the specific cryptographic key used to encode the answers. In another embodiment, each expected response within each set of expected responses is encoded using differing cryptographic keys to increase the security of the user or cardholder's expected responses. In more specific embodiments, the cryptographic algorithm(s) and key size(s) are chosen in an implementation-dependent manner, and the mechanism used is independent of the system described herein. In some embodiments, the encoding mechanism is robust enough to withstand brute force attacks against the cryptography. Triple DES, MD5, and AES are examples of suitable encoding algorithms for such robust embodiments. Cryptographic key sizes of 512 bits and larger can be employed, although the methods and mechanisms of the invention can accommodate any size key. Implementation of these features is well known to those having ordinary skill in the art. Implementation of such embodiments as just described can be done by those persons having ordinary skill in the art.

In an alternative embodiment the expected responses are stored in an automatically encrypted container, such as an encrypted database or encrypted file system, where cryptographic algorithm, key selection and key management is separated from the information stored in the system. More specific embodiments further include defenses against systemic compromise of the cryptographic key that protects each set of expected responses. Implementation of these features is well known to those having ordinary skill in the art.

In still other embodiments, a plurality of cryptographic keys is used to encode each set of expected responses. Thus, each set of expected responses, and thus the expected responses from different users or cardholders, are cryptographically encoded using differing keys. In still other exemplary implementations, the expected responses are encoded using a hash algorithm such as MD5. The hash algorithm may be varied by selecting different algorithms, keys, or “salts” on an expected result by expected result basis, or alternatively on an account-by account basis. Implementation of these encoding features is well known to those having ordinary skill in the art.

### 6.9 Generation and Processing of Authenticators

### 6.9.1 Generation of Authenticators

In some embodiments, there are several ways a user or cardholder can provide responses to the system when generating the authenticators. First, an on-line system can be provided for users or cardholders to input their responses. Those users or cardholders that are technologically literate should have no problem with this approach that can be provided in a secure environment, with initial authorization/identification criteria to be determined by the account owner. Paper responses are another possible methodology and, for that matter, the account owner could operate secure call centers for users or cardholders that are uncomfortable with either, or both, of the previously mentioned methods. Implementation of these details will be familiar to those having ordinary skill in the art.

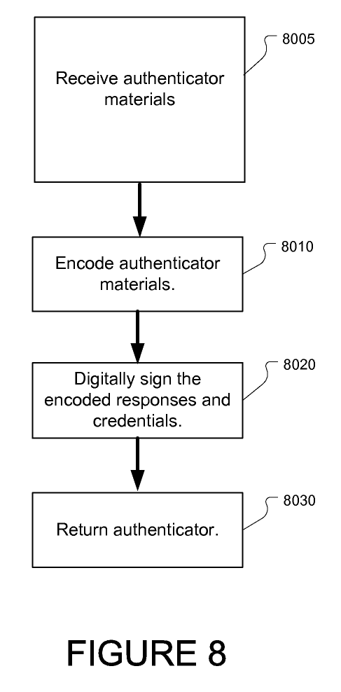

A secure processing environment may be used to generate authenticators using a process such as illustrated in FIG. 8. The secure processing environment receives an ordered set of responses from a user, an optional set of credentials, an optional hashing key, and an optional signing key (8005). If a hashing key or signing key is not provided, they must be stored within the secure processing environment. The secure processing environment then encodes the ordered set of responses, producing an ordered set of encoded responses (8010). The responses may be lengthened or algorithmically altered to produce more robust plaintext prior to the encoding process. The secure processing environment then signs the encoded responses and the optional set of credentials (if provided) using the signing key, and affixes the digital signature to the set of credentials (8020). These credentials may be used to assert the identity of a user who is able to properly respond with appropriate responses when challenged. Finally, the resulting signed hash and digital signature are then returned from the secure processing environment (8030).

In an alternative embodiment, the processing mechanism is a crypto-accelerator, and the following adaptation of the method illustrated in FIG. 8 is used. The crypto-accelerator is sequentially provided a key and each response to be encoded. If padding of the response is desired, it is performed outside the crypto-accelerator. The crypto-accelerator encodes the response and provides the encoded result. The resulting encoded responses and a wrapped copy of the encoding key are assembled. The wrapped copy may be replaced with indicia of the key if desired. The ordered list of challenge-response sets, indicia of the encoding key and signing key used, and optional credentials are passed to the crypto-processor along with a signing key. The crypto-processor creates a digital signature over the materials, optional indicia, and optional credentials. Finally, the ordered list of challenge-response sets, optional indicia, optional credentials, and the digital signature are provided to the system for further use.

A similar process may be followed outside of a secure processing environment to produce authenticators. In some embodiments, the security provided by a dedicated hardware or a controlled server environment provides sufficient protection to prevent the exposure of keys or the unauthorized creation of authenticators.

### 6.9.2 Processing of Authenticators

In some embodiments, when an account holder desires to authenticate a user or cardholder, the system prompts the user or cardholder for response(s) to one or more randomly selected questions for which expected responses already exist in the authentication system. The number of questions selected is variable and implementation dependant, depending upon each account holder's implementation desires. In those embodiments in which a plurality of account holders are using the system, each account holder may make a different selection as to the number of questions they desire expected responses to in order to authenticate a user or cardholder. Implementation of these details will be familiar to those having ordinary skill in the art.

In more specific embodiments, a user or cardholder answers selected questions presented by the authentication device. In some more specific embodiments, the user's answers are returned to the authentication service for review. In other more specific embodiments, the expected responses themselves not be transmitted, but rather an encoded version of the expected responses are returned. In still more specific embodiments, the encoding of the responses is performed used a one-way hash of the answers. In alternative embodiments, the encoding of the responses is performed using an encryption algorithm Implementation of these details will be familiar to those having ordinary skill in the art.

In other embodiments, the responses provided by the user or cardholder (or encoded versions of the responses) are compared against expected responses previously provided (e.g., the expected results within a challenge response set); and if the responses match their previously provided values, then the authentication system considers the user to be authentic. There are several approaches for providing a set of expected results from an authentication device to the authentication system. In an exemplary embodiment, where an authentication device provides a set of results to the authentication system, the corresponding pre-provided results (expected results) in the primary results set are obtained from the authentication system and compared against the provided expected results. If the results match, the user is considered authentic. The authentication device and the authentication system communicate via a secure channel mechanism such as SSL. Implementation of these details will be familiar to those having ordinary skill in the art.

In another embodiment, the authentication device produces a secure one-way hash of the results provided, and provides that hash to the authentication system. The authentication system may obtain the answers, calculate a encoding of the answers using the same algorithm as the authentication device, and then compare the resulting encoded answers against the encoded answers provided by the authentication device. If the encoded answers match, the answers provided by the user or cardholder are considered correct. A one-way hash mechanism such as MD5 is advantageous for encoding answers when the communication channel between the authentication system and the authentication device is not secure enough to prevent cryptographic attacks against the secure channel contents. Alternatively, public key or symmetric key encryption techniques may be used to encode answers. Implementation of these details will be familiar to those having ordinary skill in the art.

In still another embodiment, the results of encoding the answers are provided to a remotely located authentication device by the authentication system before the user or cardholder answers are provided. Preferably, these encoded answers are provided to the authentication device along with the questions to be asked of the user or cardholder. This approach is advantageous when the communication between the authentication system and authentication device is slow, unreliable, or is otherwise not always available. A plurality of expected results may be cached at the authentication device to permit authentication decisions when communication with the authentication system is not immediately available. This approach is advantageous when a limited number of user or cardholders use a specific authentication device. Implementation of these details will be familiar to those having ordinary skill in the art.

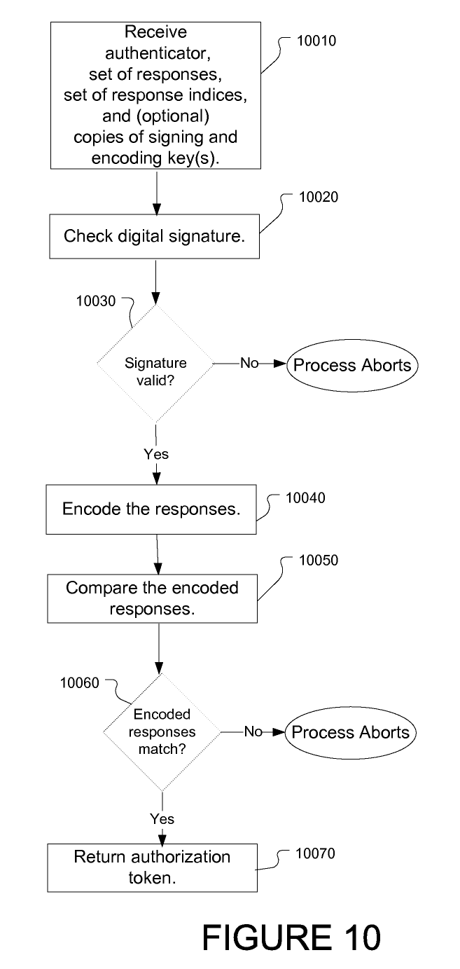

FIG. 10 illustrates one embodiment of a method for processing authenticators by a secure processing environment in accordance with the present invention. The secure processing environment receives authenticators, comprising one or more of a set of encoded expected responses, a set of response indices, and an optional copy of the appropriate signing and hashing key(s) to be used to check the digital signatures of the authenticator and to generate encoded responses (10010). If signing and hashing keys are not externally provided, the secure processing environment uses appropriate copies of the keys stored within the secure processing environment. The secure processing environment checks the digital signature of the authenticators (10020) using the appropriate signing key. If the digital signature of the authenticators does not pass the digital signature checks (10030), the process is aborted and an invalid authorization token is returned. The secure process environment encodes the provided user or cardholder responses using the same encoding algorithm used to produce the initial encoded expected results (10040). This produces encoded results. Any necessary padding is applied prior to calculating the encoded results. The resulting encoded results are compared to the corresponding expected encoded results in the authenticators on an result by result basis (10050). Thus, a newly generated encoded result with index 3 is compared to the third expected result in the authenticator. After all results and expected results are compared, if the results and expected results do not match, the process is aborted and an invalid authorization token is returned (10060). An authorization token is constructed (10070) by creating an authorization response, combining the response with whatever credentials are part of the authenticator, and signing the authorization with the signing key, and affixing the digital signature as part of the authorization.

Each step of the above process may be performed entirely within a secure processing environment, or may be performed outside the secure processing environment using the secure processing environment as a hashing and signing engine. Alternatively, the process may be performed using a crypto-accelerator. Implementation of these alternative embodiments will be apparent to those having ordinary skill in the art.

In yet another embodiment, the failure to answer any question correctly within a certain response period (e.g., as set by the account holder) provides the user or cardholder an additional attempt at another question. In some embodiments, the question so presented is chosen randomly. The feature may be associated with any question and may be used limit access while impaired or may be used to enforce a degree of familiarity with the questions by the holder. Providing an incorrect answer the second time would result in the production of a non-authenticated indication. This may be used to freeze the user or cardholder's account(s), or may have other consequences. Alternatively, another question may be displayed. Failure to answer the third question correctly results in a second non-authenticated indication, which may lead to more stringent consequences, such as suspending the account and, depending on the wishes of the account holder, can either require personal contact by the user or cardholder with the account holder for re-activation, or be re-activated with supplying a correct answer to another (one or more) randomly selected question(s). Implementation of these details will be familiar to those having ordinary skill in the art.

In some embodiments, a secure processing environment may accept authenticators, and then accept inputs one at time from a user until they have tried a specific number of responses (or until the process times out waiting on the user).

In other embodiments, to process authenticators where all of the responses have not been provided beforehand, the secure processing environment receives an intra-response timeout, authenticators, a number of expected responses, and an optional copy of the appropriate signing and hashing key(s) to be used to check the digital signatures and to generate copies of the encoded responses.

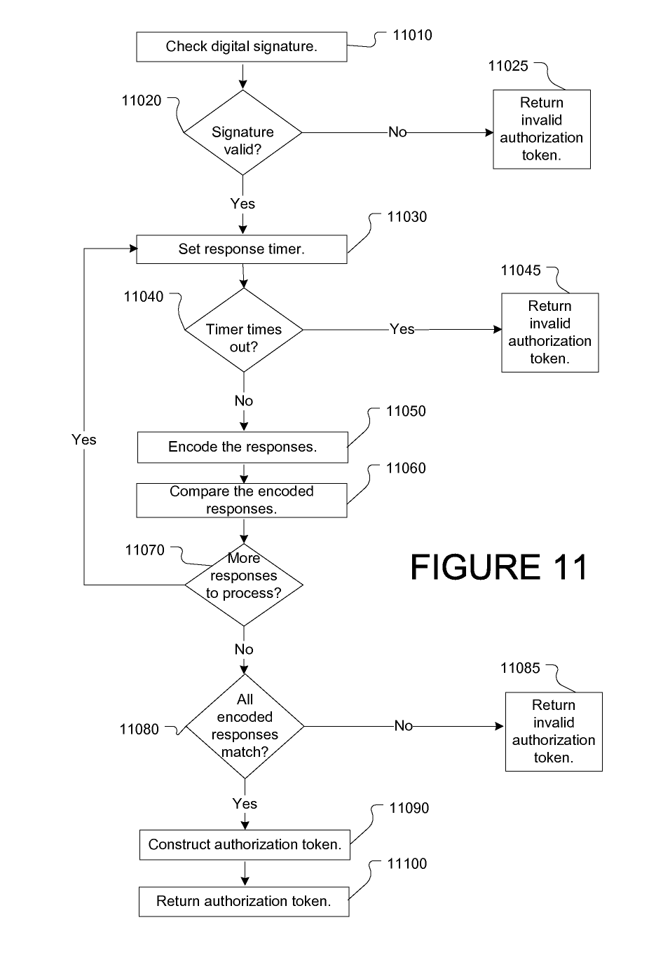

FIG. 11 illustrates one embodiment of a method for processing authenticators where the user is required to provide the responses as input to the authentication device. The authentication device checks the digital signature of the authenticator(s) (11010). If the digital signature of the authenticators does not pass the checks (11020), the process is aborted and an invalid authorization token is returned (11025). The authentication device sets a response timer and waits for input of a new response and index (11030). If the timer expires prior to receiving an expected input (11040), the process is considered to have failed and returns an invalid authorization token (11045). The authentication device encodes the newly input response using the same algorithm and keys used to produce the initial encoded response (11050). The resulting encoded response is compared to the authenticators corresponding expected encoded response on an index-by-index position basis (11060). Thus, a newly generated encoded response for the third question is compared to the third encoded, expected result within the authenticator. The process continues until the expected number of responses have been received and processed (11070). If all encoded responses do not match their corresponding encoded expected results (11080), an invalid authorization token is returned (11085). An authorization token is constructed by creating an authorization response, combining the response with whatever credentials are part of the authenticator, and signing the authorization with the signing key, and affixing the digital signature as part of the authorization (11090). The authorization token is returned (11100).

In some embodiments, a suspension or freeze, of a first account will make suspect or freeze all accounts associated with a specific user.

### 6.9.3 Authentication of the Holder Following Compromise

In some embodiments, if user or account holder realizes that their initial set of responses has been compromised, the authentication system allows the user or account holder to immediately shut down the use of the compromised data. Therefore, those stealing the data, within virtually minutes, have data that is worthless. In more specific embodiments, the authentication system immediately goes to back-up responses and the challenge-response mechanisms described above use an alternate set of expected responses instead of the primary expected responses. The primary expected responses and secondary expected responses may be encapsulated within a single authenticator, or may be part of separate authenticators. The use of any compromised accounts will simply get a message when the authorized holder attempts to use their account that they are to use their back-up responses. Once the user or cardholder has been successfully authenticated, the user or cardholders will have to then provide a new set of expected responses so there are again two sets of responses in the system. It can be the account holders, or the user or cardholder's choice, which set of responses become primary and which becomes the back up. The process for supplying a new set of responses is the same as the process for providing initial responses. Implementation of these details will be familiar to those having ordinary skill in the art.

### 6.10 Authentication Device

Returning to FIG. 1, the authentication device (1200) is, in one embodiment, a data entry device that accepts authenticators from an external source, including an identification device, authentication service, provisioning service, transaction service, authenticator store, or other service of the authentication system (described above); and further is configured to provide user displays of challenge questions, and prompt the user for one or more responses as appropriate. In some embodiments, the authentication device includes a data entry terminal (e.g., a web browser or custom application), a cell phone, a personal data assistant (PDA), an embedded system, such as in an automobile, a point-of-sale (POS) keypad, RFID receiver, biometric sensor, or other device capable of accepting authenticators, displaying challenges, and accepting responses from an holder. Such devices are familiar to those persons having ordinary skill in the art.

In some embodiments, the authentication device also processes the data and returns one or more results. The authentication device may be constructed using a commercially available operating system component, such as Windows CE, Linux, Symbian, or PalmOS. Alternatively, the authentication device may comprise dedicated hardware, firmware, and software that do not include a commercial operating system component. Implementation of these details will be familiar to those having ordinary skill in the art. In still other embodiments, upon the operating system architecture selected, an authentication device may not support formal “services”. As defined herein, “service” includes combining of described functionality within other modules or components of a system. Implementation of these details will be familiar to those having ordinary skill in the art.

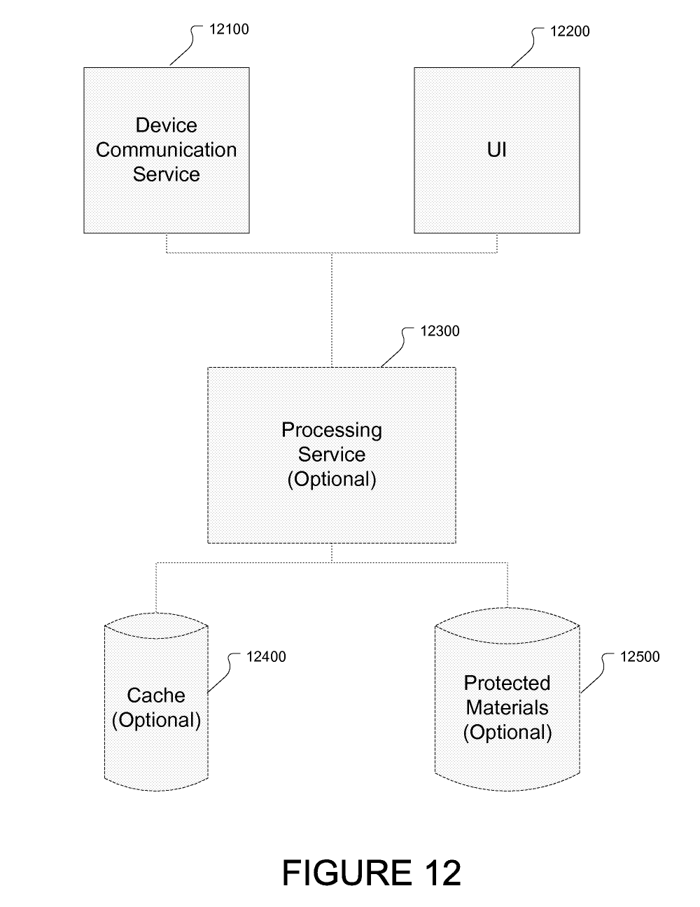

FIG. 12 depicts an embodiment of an exemplary authentication device in accordance with the present invention, including: a device communication service (12100), a user interface (12200), optional processing service (12300), optional cache (12400), and optional protected materials (12500). In the illustrated embodiment, the device communication service communicates with the communication service of an authentication server (described above) using communication means available to the authentication device (not shown). The user interface component displays questions from an authentication server, and collects responses from the user. If the optional processing service (12300) is available, it receives responses from the user or cardholder, processes them, and compares the processed responses to the expected responses within an authenticator provided by the communication server to produce an authenticated/non-authenticated indication. The authenticator(s) may be optionally cached in the cache (12400) to reduce the required communications bandwidth. Alternatively, many sets of authenticator(s) may be pre-cached in the authentication device to permit stand-alone operation of the authentication device. In some embodiments, access to protected materials is provided if the holder has successfully authenticated. Correspondingly, access to the protected materials is denied if the user is not authenticated. Implementation of these details will be familiar to those having ordinary skill in the art.

In a one exemplary embodiment, an authentication device is deployed within a point-of-sale keypad. The authentication device uses a network or serial connection to communicate with an authentication server to provide additional authentication of the holder during a card-based (e.g., credit or debit card) transaction. In an alternative embodiment the point-of-sale keypad is connected directly to one or more systems having account information, and the holder provides only their account and authentication information. Persons having ordinary skill in the art will be familiar with providing such devices and capabilities.

In another aspect, an authentication device provided by the present invention is deployed within a cell phone or other portable communications device (e.g., PDA or laptop or notebook computer). In one embodiment, the authentication device uses cellular technologies (e.g., SMS or GPRS) to establish and maintain communication with one or more authentication servers to provide interactive authentication of the cell phone user. Persons having ordinary skill in the art will be familiar with providing such devices and capabilities.

### 6.11 Applications of the Invention

### 6.11.1 Point-of-Sale Transactions

An exemplary use of an authentication device provided by the invention, such as the embodiment described above, is embedded within a “card swipe” machine common wherever ATM, debit, or credit card transactions are available. When an account issuer suspects that a transaction card has been stolen or compromised, the account issuer can request that the authentication device issue several challenges to the user (or cardholder) in the form of questions for which the user or cardholder has established pre-initialized expected responses within the authentication system. If the user or cardholder is able to correctly answer with their responses, then the transaction is permitted to complete as the account issuer has assurance that the user or cardholder is still in possession of their card. Authentication device technology may also be embedded within web-based merchant storefronts (e.g., Amazon) to improve the integrity of these transactions.

### 6.11.2 Use of the Invention for Securing Wireless Device Contents

In another aspect, the authentication devices and methods provided by the invention are used in conjunction with a portable communications device, such as a cell phone or PDA (e.g., a Blackberry or Treo). In one embodiment, the authentication device is configured to pre-cache authenticators or communicate using the wireless features of the device with an identification device, authentication service, or provisioning service. In a first alternate exemplary use, when a user (or account holder) attempts to access personal information stored on the device, the user (or holder) is first challenged with a series of questions to which they have established pre-initialized expected responses within the authentication system. If the user (or account holder) provides the expected response(s), access to the personal information is provided, at least in part in response to an authenticated indication. Failure of the user (or account holder) to provide the expected responses results in the personal information remaining locked. Data locking of a device's personal information (e.g., calendar, email, phone directory, call logs) may be accomplished using cryptographic techniques or by access control. Implementation of these details will be familiar to those having ordinary skill in the art.

In some embodiments, a user or account holder sets up their authenticators in the authentication system and subscribes with their cellular carrier so that their cellular telephone or PDA (e.g., Blackberry) is content-protected using the authentication service provided by the invention. The personal information on the device is encrypted using a cryptographic algorithm and a key based upon a cryptographic hash of the user or account holder's authenticator, or using a cryptographic hash of the plain text of an authenticator's encoded expected response. Alternatively, the key used to protect the personal information is itself encrypted using a cryptographic hash of the plain text of an authenticator's encoded expected response. Note that, in the second approach, multiple instances of the key may be protected using different combinations of the plain-text answers, permitting the key to be accessed whether the holder successfully answers the primary or alternative set of questions. The keys and cryptographic protections are established when the device is associated with the authentication system and an account. Implementation of these details will be familiar to those having ordinary skill in the art.

If the account holder believes that a wireless device may no longer be in the hands of an appropriate operator, they may send a message to the device using a standard cellular messaging protocol such as SMS. The decision to send an authentication request message to the wireless device may be made base upon time, usage patterns, or other factors. The wireless device receives the message and routes it to the device communication service, where it is then processed. Implementation of these details will be familiar to those having ordinary skill in the art.

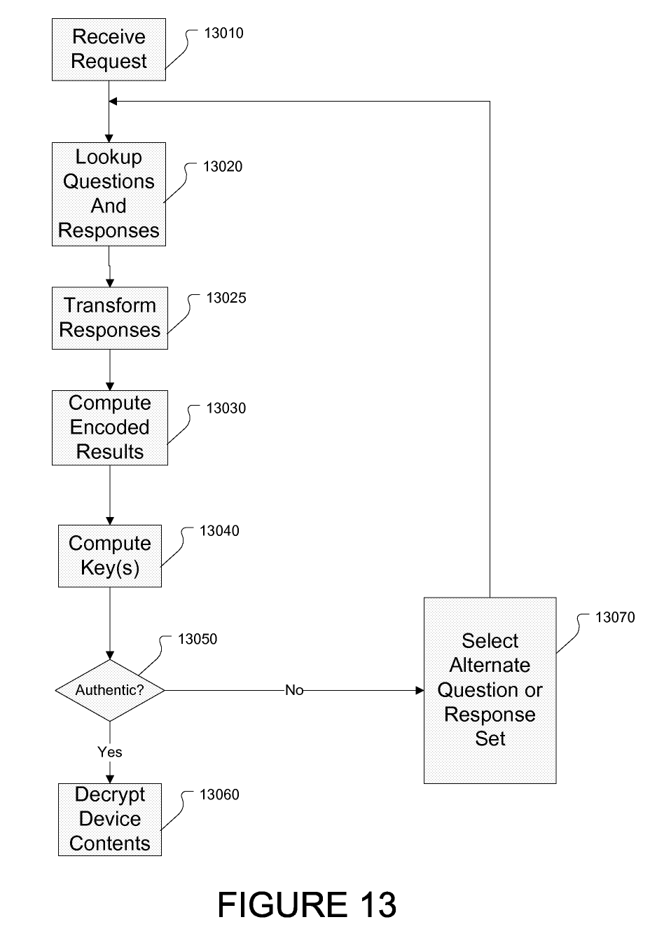

FIG. 13 illustrates a flowchart of the operation of a wireless communications device comprising the authentication device technology being used to protect the contents of the device in accordance with an exemplary embodiment of the invention. Initially, the wireless device receives a message from the account holder and routes it to the device communications service (13010). The wireless device then looks up the questions to be asked and prompts the holder for responses to these questions (13020). The holder provided answers are transformed (if required) (13025), and then used to compute at least one encoded result (13030), and at least one content protection key (13040). The encoded result(s) are compared against the encoded expected results stored in the authenticator (13050). An authenticated indication releases the content protection key to decrypt the device contents (13060). Alternatively, the unencoded answers may be used with an alternate encoding mechanisms to generate a content protection key. A non-authenticated indication prompts the user for a response using the alternative set of expected results, if any (13070). Implementation of these details will be familiar to those having ordinary skill in the art.

An authentication device may alternatively request authenticators from an authentication server and then operate as described above if desired.

An authentication device may include a secured environment to improve performance and tamper resistance. Secured environments may not be used to store cryptographic materials. Most secured environments have one or more public keys embedded into their ROM/PROM code. They may use these keys to generate a private key, or in conjunction with calculated materials to unwrap a wrapped private key stored using alternative methods. Secured environments are inherently “crackable” given sufficient time and resources.

Secured environments, once they are securely booted, may be used in conjunction with externally supplied cryptographic materials to:
Generate authenticators,
Validate one or more responses against authenticators, and
   Attest that a specific user has authenticated using one or more authenticators, and
   Attest that a specific credential has been authenticated using one or more authenticators.

In some instances, sufficient security may be provided within a dedicated (network) appliance such as credit card reader or other tamper resistant embedded device to permit the use of these algorithms without the use of secure processing techniques. These types of devices may use techniques described herein to distribute keys and result sets to a client for processing.

Secure processing techniques, Trusted Processing Modules (TPM) and trusted crypto-processors (collectively secure platforms) may be used with stored cryptographic materials to operate on authenticators as follows:
To generate authenticators and parts of authenticators,
To validate one or more responses against authenticators, and
To attest that a specific user has authenticated using one or more authenticators, and
To attest that a specific credential has been authenticated using one or more authenticators.

### 6.11.3 Limitation of Denial of Service Attacks and Automatic Recovery

In other embodiments, when a holder attempts to use the system to gain access, and they answer their questions incorrectly, they may, at the account issuer's option, be prompted with additional questions from the primary set. In more specific embodiments, if the user is able to answer these questions successfully, they may be considered authentic. But if the holder is unable to answer these questions, the account may be locked. In other such embodiments, if a data compromise is suspected of the primary answer set, the account may be locked until the holder re-authenticates.

In some embodiments, if the user's account is locked because of data compromise or invalid access attempts, the holder may be authenticated (at a later time) using the secondary set of responses as described above. If the user or cardholder successfully authenticates using the secondary set of responses, the account lock may be removed.

### 7 COMPUTER APPARATUS

The software, systems, and methods described herein can be implanted on a standard general purpose computer using methods known to those of ordinary skill in the art. A representative computer includes, shown in FIG. 14 at 14000 a central processing unit (CPU, 14002) which is coupled bidirectionally with random access memory (RAM, 14004) and unidirectionally with read only memory (ROM, 14006). Typically, RAM is used as a “scratch pad” memory and includes programming instructions and data, including distributed objects and their associated code and state, for processes currently operating on CPU. ROM typically includes basic operating instructions, data and objects used by the computer to perform its functions. In addition, a mass storage device (14008), such as a hard disk, CD ROM, magneto-optical (floptical) drive, tape drive or the like, is coupled bidirectionally with CPU (14002). Mass storage device generally includes additional programming instructions, data and objects that typically are not in active use by the CPU, although the address space may be accessed by the CPU, e.g., for virtual memory or the like. Each of the above described computers optionally includes an input/output source (14010) that typically includes input media such as a keyboard, pointer devices (e.g., a mouse or stylus) and/or network connections. Additional mass storage devices (not shown) may also be connected to CPU through a network connection (14012). It will be appreciated by those skilled in the art that the above described hardware and software elements, as well as networking devices, are of standard design and construction, and will be well familiar to those skilled in the art.

### 8 CONCLUSION

As will be appreciated by those having ordinary skill in the art, the systems, methods, and software provided by the present invention enable authentication such that, in certain embodiments, anyone attempting to use an account (e.g., a credit card or debit card) or steal the identity of someone else, would have to know the responses to questions which are randomly invoked, and displayed for answer on an authentication device (this, keeping vendors from having to retool most POS terminals). So, even if the perpetrator knew the holder, and knew the correct responses to the questions, that knowledge would be of no value. Thus, even a relative (son, daughter, husband wife, mother, or father) would be unable to use the card/identity. This also effectively puts an end to loss from “shoulder surfing”, due to the fact that the chances of the surfed “answer” coming up again at any predictable time, make it impractical for the criminal.

A benefit of the described systems, methods, and software provided by the present invention, aside from restricting unauthorized use of card or identity, is that the authorized holder can re-activate the account simply by providing a correct response to one or more questions (again, the choice of the account holder). The resultant operational cost savings are staggering. No more holder service involvement, no more wholesale shutting down of account numbers and issuing new cards, no more interruption or inconvenience to the holder or the merchant(s). So, aside from the obvious benefits of fraud prevention, the massive operational costs associated with this problem are dramatically reduced, or eliminated, altogether.

Additionally, users will benefit from the integration of the systems, methods, and software provided by the present invention with existing transaction protocols and backend database systems, to extend the authentication methodologies provided by the present invention to current systems having millions of customers. Such integration will be recognized by those of ordinary skill in the art will as largely transparent to the end users (i.e., customers).

Although various specific embodiments and examples have been described herein, those having ordinary skill in the art will understand that many different implementations of the invention can be achieved without departing from the spirit or scope of this disclosure.

What is claimed:

1. A method for authenticating an first entity to at least one other entity, comprising:
creating authenticator effective to authenticate said first entity to said at least one other entity;
providing said authenticator or a substantially secure derivative thereof to an intermediary authentication service configured to interrogate said first entity;
receiving a response to an identity interrogation from said first entity at said intermediary; and
comparing at said intermediary the content of said response, or a derivative of said content, to said authenticator or said substantially secure derivative thereof to generate an estimation as to whether said first entity is authentic at said intermediary.

2. The method of claim 1, further including determining whether said authenticator are valid.

3. The method of claim 2, further including the step of generating new authenticator if said authenticator are determined to be invalid.

4. The method of claim 3, further comprising receiving additional authenticator or derivatives thereof from said at least one other entity at said intermediary.

5. The method of claim 4, further comprising sending said estimation to said at least one other entity.

6. The method of claim 1, further comprising sending said estimation to said at least one other entity.

7. The method of claim 1, further comprising receiving additional authenticator or derivatives thereof from said at least one other entity.

8. The method of claim 1, wherein said derivatives of said authenticator are secure representations of said authenticator, and providing said secure representations to said first entity and said intermediary.

9. The method of claim 8, wherein said first entity provides said secure representation to said intermediary, and said comparison comprises comparing said secure representation provided by said first entity to said secure representation provided to said intermediary.

10. The method of clam 9, wherein said secure representation is a hash derived from said authenticator.

11. The method of claim 8, wherein said secure representation sent to said first entity are recorded on a data storage device.

12. The method of claim 11, wherein said data storage device comprises a card.

13. The method of claim 11, wherein said data storage device comprises a portable communications device.

14. A system for authenticating an first entity to at least one other entity, comprising:
authenticator configured to authenticate said first entity to said at least one other entity; and
an intermediary authentication service configured to interrogate said first entity, said intermediary configured to receive a response to an identity interrogation from said first entity and compare the content of said response, or a derivative of said content, to said authenticator or a substantially secure derivative thereof, and generate an estimation as to whether said first entity is authentic.

15. The system of claim 14, wherein said first entity comprises a data storage device configured to store said authenticator or a derivative thereof.

16. The system of claim 14, wherein said authenticator comprise a digital signature and an ordered set of hashes.

17. The system of claim 16, wherein said authenticator further comprise credentials and indicia.

18. The system of claim 17, wherein said indicia comprises a signing key and a hashing key.

19. The system of claim 14, further comprising an authenticator generating mechanism configured to generate said authenticator.

20. The system of claim 19, further comprising an authenticator storage mechanism configured to store said authenticator.

21. The system of claim 14, wherein said at least one entity comprises a transaction service.

22. The system of claim 21, wherein said transaction service is configured to provide authenticator to said intermediary.

23. The system of claim 14, wherein said first entity comprises a data storage that is configured to hold said authenticator or a substantially secure derivative of said authenticator.

24. The system of claim 23, wherein said data storage device is configured in a card format.

25. The method of claim 23, wherein said data storage device comprises a portable communications device.
